(19) United States
(12) Patent Application Publication
(10) Pub. No.: US 2022/0163619 A1
(43) Pub. Date: May 26, 2022

(54) DEVICE FOR ATTACHMENT TO AN OPENING OF A VEHICLE AND FOR COVERING AN EMITTER AND/OR A RECEIVER

(71) Applicants: Hella Saturnus Slovenija d.o.o., Ljubljana (SI); Hella GmbH & Co. KGaA, Lippstadt (DE)

(72) Inventors: Luka Kocan, Trebelno (SI); Ales Lindic, Dol pri Ljubljani (SI); Bostjan Janezic, Zagradec (SI); Uros Rozanc, Ilirska Bistrica (SI); Karlheinz Kandler, Schluchsee (DE); Sven Jedamzik, Schönau (DE); Till Potente, Detmold (DE)

(21) Appl. No.: 17/650,180

(22) Filed: Feb. 7, 2022

Related U.S. Application Data
(63) Continuation of application No. PCT/EP2019/074248, filed on Sep. 11, 2019.

(51) Int. Cl. G01S 7/02; G01S 13/931; H01Q 1/42

(52) U.S. Cl. CPC G01S 7/027; G01S 2013/9327; H01Q 1/42; G01S 13/931

(57) ABSTRACT

A device is provided for attachment to an opening of a vehicle and for covering an emitter and/or a receiver of electromagnetic waves (W), in particular radar waves. The device is arranged in the vehicle behind the opening, and includes a covering plate which, when attached to the opening, completely covers the opening. The covering plate is composed of a material that is at least partially transparent to electromagnetic waves. The covering plate is the only plate that covers completely the opening.

### CROSS-REFERENCE TO RELATED APPLICATIONS

This application is a continuation of and claims priority to PCT Application No. PCT/EP2019/074248, which was filed Sep. 11, 2019, the entirety of which is hereby incorporated by reference.

### FIELD OF THE INVENTION

The invention relates to the technical field of devices for attachment to an opening of a vehicle and for covering emitters and/or receivers of electromagnetic waves, such as radar waves.

### BACKGROUND OF THE INVENTION

Such an opening can be located at the vehicle body at a position where the emblem of the vehicle manufacturer is located, and behind the opening an emitter or receiver of electromagnetic waves could be placed.

KR 101856441 describes a cruise control sensor cover for a vehicle, and a manufacturing method thereof.

WO 2019/066184 A1 describes a vehicle cruise control sensor cover and a manufacturing method therefor.

US 2016/298226 A1 describes a coating process and device for producing a selective metalization of motor vehicle lighting device and/or signaling parts.

CN 109204178 A describes a positioning and mounting structure of an automobile main logo.

### BRIEF SUMMARY OF THE INVENTION

It is an object of the present invention to provide an improved device for attachment to an opening of a vehicle and for covering an emitter and/or a receiver of electromagnetic waves, in particular radar waves, arranged in the vehicle behind the opening. The device may in particular be improved such as to provide a better passage for the electromagnetic waves, for example, that attenuation, reflectivity and/or homogeneity of the emitted electromagnetic waves are improved and/or that angular errors are reduced. The device may also be improved such as to provide a desired visual appearance.

In some embodiments, a device for attachment to an opening of a vehicle, in particular a vehicle body, and for covering an emitter and/or a receiver of electromagnetic waves, in particular radar waves, arranged in the vehicle behind the opening, comprises: a covering plate which, when attached to the opening, completely covers the opening, the material of the covering plate being at least partially transparent to the electromagnetic waves, and the covering plate being the only plate that covers completely the opening.

The device or apparatus may serve as a cover. The cover may carry the emblem of the vehicle manufacturer and the cover is intended to be arranged on the vehicle, in particular on the vehicle body, such as on the hood, for covering an emitter of a radar system that is placed behind the manufacture's emblem and configured to emit radar waves in the driving direction of the vehicle. The device can therefore be regarded as a radar dome or radome.

The cover plate of the device is the only plate that covers the opening, and hence, the cover plate forms the only obstacle through which the electromagnetic waves have to pass before they leave the vehicle body to the outside.

In comparison with a solution that employs two superimposed layers of plates, for example a front plate and a rear plate, to cover the opening, the device in accordance with the present invention is particularly advantageous as the covering plate is the sole plate which completely covers the opening. The single covering plate enables a relative homogeneous transparency for electromagnetic waves over the complete opening. Disturbing structures in the one plate can be easier avoided. Plate thickness can be uniformly provided and can be relatively small, and the amount of used material is reduced. Additionally, air gaps that may occur between two plates are avoided. As a result, the device can help to improve the performance of an emitter or receiver of electromagnetic waves that is covered by the covering plate of the device.

The covering plate can comprise a foil, in particular a metal foil, on which a styling, such as an emblem or logo of a manufacturer, may be applied. The foil can be in-molded in a material, so that the material and the foil together can form the covering plate.

According to some embodiments of the present invention, the device can comprise a frame to which the covering plate is fixed or fixable, in particular by gluing. The frame can comprise one or more fasteners for fixing the device to the vehicle body. The application of a frame enables an additional member being especially adapted for mounting the device to the opening of the vehicle without interfering with the device transparency (or partial transparency) for the electromagnetic waves.

The frame can provide an outer area of frame material surrounding an inner area being free of frame material. The frame can be mechanically fixed or glued to an outer rim of the covering plate. Alternatively, the frame can be molded, such as 2 K molded, on the covering plate. An inner area of the covering plate enables at least partial transparency to the electromagnetic waves, and it can be ensured that the covering plate is the only plate that covers completely the opening, while the frame can surround the opening and serve to attach the device to the vehicle, such as the vehicle body. Thus, the frame surrounds the opening and does not provide any material at an inner area of the covering plate. Hence, only the covering plate forms an obstacle for the electromagnetic waves.

The frame can provide one or more fasteners serving as fixing means for fixing the frame to the vehicle body. The fasteners can be formed on the frame side and/or they can be turned away from the covering plate. The fasteners can be part of a snap fit system and they can be configured to cooperate with receiving elements on the vehicle body.

The fasteners can be material parts perpendicularly extending out from the frame material on the side of the frame material, which is opposite to the side to which the covering plate is attached. Thus, they can face away from the covering plate. The material of fasteners can be equal or similar to the one of the frame. The frame and the one or more fasteners also can be formed as a single piece. The material parts can be studs or tongues. Each fastener can optionally provide an area on which glue can be applied.

The frame at least in substance can run around the opening when the device is fixed to the vehicle or vehicle body. Thus, the frame can circumferentially encircle the opening after the device is used as intended and properly placed on the vehicle body or vehicle.

In particular, the frame can comprise one or more frame elements that are circumferentially surrounding the covering plate and that do not create any relevant obstacles for the electromagnetic waves. The frame can be seen as an adapter between covering plate and vehicle and in particular as a means to fix the covering plate to the vehicle.

The frame can have a ring-like form. The frame can comprise an outer area of frame material surrounding an inner area being free of frame material. Since the covering plate can have the shape of a disk, the preferred form for the frame is a ring form.

The covering plate and the frame can be separated pieces. Thus, the covering plate and the frame can be produced separately. This can simplify the process of manufacturing the covering plate, in particular if the covering plate shall fulfil a further function, such as bearing an emblem.

The covering plate and the frame can be integrally formed with each other, for example in a molding process, in particular via 2 K molding. The frame and covering plate can thus be made in a single piece.

Alternatively, the covering plate can comprise one or more fasteners for fixing the device to the vehicle body, the covering plate and the fasteners being integrally formed with each other. Thus, a frame may not be required. An inner area of the covering plate through which the electromagnetic waves pass through is, however, free of fasteners.

According to some embodiments of the present invention, the covering plate can provide a homogenous layer and/or at least in substance can have a consistent thickness and/or a circular circumference. Disturbing structures and/or obstacles in the covering plate can thereby be avoided. By using a circular circumference of the covering plate breakable corners can also be avoided.

The covering plate can be at least slightly domed. Thus, the covering plate in this case is not flat. For example, it can have the form of a curved or domed disc. This may help to improve the mechanical stability and appearance of the covering plate. Moreover, an adjustment with respect to the position of the emitter and/or the receiver of electromagnetic waves, in particular radar waves, can be performed. For example, due to the curved structure an inner, central area of the covering plate can have the same distance to the emitter and/or the receiver as an outer area of the covering plate. Accordingly, electromagnetic wave transparency performance of the device can be improved.

According to some embodiments of the present invention, the covering plate can at least partially consist of a molded plastic material. Plastics are easily available, light, flexible, resilient, easy to handle and provide at least partial transparency properties to electromagnetic waves, for example radar waves and/or light waves. Example for plastics can be polycarbonate, polypropylene, polyethylene, etc. Molding is a known reliable method for creating pieces of plastic.

According to some embodiments at least a front side and/or a rear side of the covering plate can be at least partially covered by at least one styling layer of a cover material, in particular a metal. The front side can be the side of the covering plate which is facing away from the opening of the vehicle when the device is attached to the vehicle body. Thus, the front side can be located at and visible from the outer side of the vehicle body after the device is attached to the vehicle body. The rear side can be the side of the covering plate which is facing towards the opening and towards the emitter and/or receiver when the device is, when in use as intended, attached to the vehicle body.

According to some embodiments of the present invention, a light emitting source could be positioned behind the opening of the vehicle body of the vehicle to provide some illumination effects concerning the emblem. In this case the material of the covering plate can be at least partially transparent to the emitted light.

According to some embodiments of the present invention, the at least one styling layer can be manufactured to include, carry or display the emblem of the vehicle manufacturer. Accordingly, the device can show a logo associated with the manufacturer of the vehicle to indicate the origin and to distinguish from other manufacturers. The styling layer can also consist of or comprise a foil on which a styling is applied. The styling can provide the logo or emblem of the vehicle manufacturer.

The invention also relates to a method of producing a device for attachment to an opening of a vehicle, in particular a vehicle body, and for covering an emitter and/or a receiver of electromagnetic waves, in particular radar waves, arranged in the vehicle behind the opening, in particular a device in accordance with the present invention, the method can comprise the steps of: providing a covering plate which, when attached to the opening, completely covers the opening and is the only plate that covers completely the opening, the material of the covering plate being at least partially transparent to the electromagnetic waves, at least partially covering at least a front and/or a rear side of the covering plate by a styling layer of a cover material, in particular a metal, and removing material from the styling layer for producing an emblem of the vehicle manufacturer on the front side and/or on the rear side of the covering plate or using a foil as cover material and producing the emblem in the foil.

The styling layer can have a small thickness, in particular in a range of a few μm. Thus, removing material from the styling layer causes merely a small change of thickness of the covering plate. The radiation emitted by the sender and/or received by the receiver therefore may not be disturbed due to the thin styling layer with material removals. Preferably, the styling layer material is removed to achieve a desired design, e.g. of a logo or emblem.

According to some embodiments of the present invention, the covering plate can be produced in a molding process, in particular by use of a plastic material and for example in an injection molding process. Molding is a reliable method for creating pieces of plastic. Plastics are easy to be processed.

The styling layer can be produced by metallization of the covering plate. Thus, the metallized styling layer can be made very thin. Material can therefore be saved. The metal can be removed easily. The styling layer can also comprise or consist of a foil, in particular a metal foil. The foil can be attached to the front side of the covering plate.

The step of removing material from the styling layer, for example for producing an emblem of the vehicle manufacturer, on the front side and/or rear side of the covering plate can comprise one or more steps in which a laser can be used for removing material from the styling layer.

According to some embodiments of the present invention, one or more sprues can be removed from the covering plate. A sprue can result from the passage through which liquid material is introduced into a mold. During casting or molding, the material in the passage will solidify and the resulting sprue needs to be removed from the molded piece.

According to some embodiments of the present invention, at least one lacquering step can be performed on the covering plate, in particular on the front side and/or on the rear side of the covering plate. A lacquer can protect the covering plate and/or the styling layer. It can also be used for thickness compensation of the styling layer after material removal. The lacquer can also improve the surface quality and appearance of the front side of the covering plate. Moreover, it can provide at least a partial feature of the design of a manufacture's emblem. The lacquer can be transparent or coloured.

According to some embodiments of the present invention, the method can comprise a step of providing a frame with one or more fasteners for fixing the device to the vehicle body, wherein, preferably, the frame can be provided by a molding process.

According to some embodiments of the present invention, the covering plate can be fixed, in particular by gluing, to the frame. For example, a gluing process can be performed with a certain temperature and/or under a certain pressure. The gluing can be carried out at room conditions. Other techniques to fix the covering plate to the frame can also be used, for example 2 K molding or laser welding, etc.

According to some embodiments of the present invention, a step of measuring the efficiency of passage of electromagnetic waves, in particular radar waves and/or light waves, through the covering plate can be carried out. Measured parameters can be attenuation, reflectivity and/or homogeneity of the passage of electromagnetic waves.

### BRIEF DESCRIPTION OF THE DRAWINGS

Reference is now made more particularly to the drawings, which illustrate the best presently known mode of carrying out the invention and wherein similar reference characters indicate the same parts throughout the views.

FIG. 1 shows schematically in a top view an embodiment of a device which is not covered by the present invention.

FIG. 2 shows schematically in a top view an embodiment of a device according to the present invention.

FIG. 3 shows schematically the device of FIG. 2 in an exploded view.

FIG. 4 shows schematically a flow diagram of an embodiment of a method for manufacturing a device according to the invention.

FIG. 5 shows schematically a front view of the device of FIG. 2.

FIG. 6 shows schematically a rear view of the device of FIG. 2 together with a beam of electromagnetic waves.

### DETAILED DESCRIPTION OF THE INVENTION

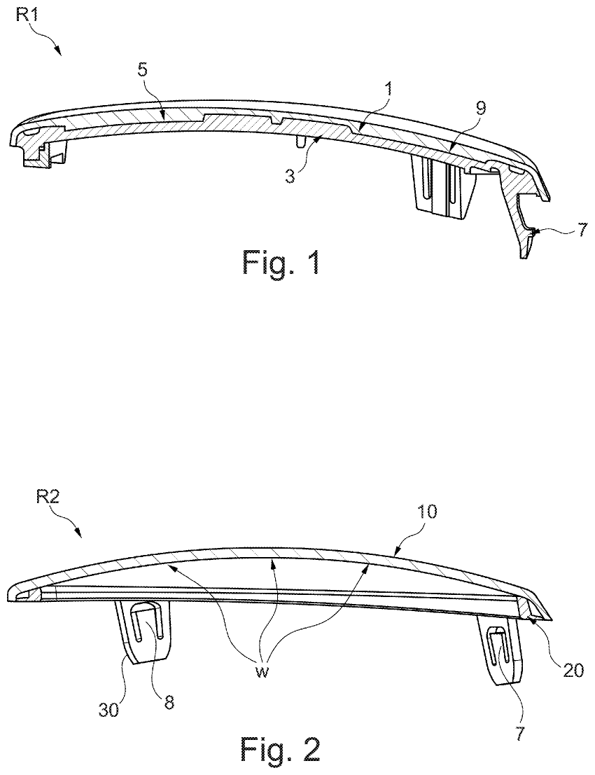

The device shown in FIG. 1 can be called a radar dome or a radome R1. The radome R1 comprises a front plate 1 and a rear plate 3 that form two superimposed layers of plates. When the radome R1 is fixed to a vehicle or vehicle body (not shown), the front and rear layers 1, 3 cover an opening behind which an emitter and/or receiver of a radar system can be placed. The radome R1 allows radar waves to pass through its front plate 1 and rear plate 3.

On a rear side of the front plate 1, a styling 5 can be applied which can be defined for example by a customer. The styling 5 can for example represent a customer's logo. Furthermore, a snap-fit system 7 on the back plate 3 can be used to fix the radome R1 to the vehicle body, for example a fascia or a grill of a vehicle.

In order to obtain a good radar performance, the thickness of the radome R1 is preferably even and constant. The geometry of the back plate 3 can compensate for thickness differences arising from the front plate 1, mainly because of the styling 5. However, between the front plate 1 and the back plate 3, one or more air gaps 9 may occur, for example because the plates 1, 3 are glued or joined together by other processes like laser welding etc. The two plates 1 and 3 as well as possible air gaps 9 may diminish the performance of the radar system.

The exemplary embodiment of a device in accordance with the present invention, as shown in FIGS. 2, 3, 5 and 6, also serves as a radome R2 and is intended for attachment to an opening of a vehicle and for covering an emitter and/or a receiver of a radar system arranged behind the opening (not shown).

The radome R2 comprises a covering plate 10 which, when attached to the opening, completely covers the opening, and the covering plate 10 is indeed the only plate that covers completely the opening. The material of the covering plate is at least partially transparent for radar waves.

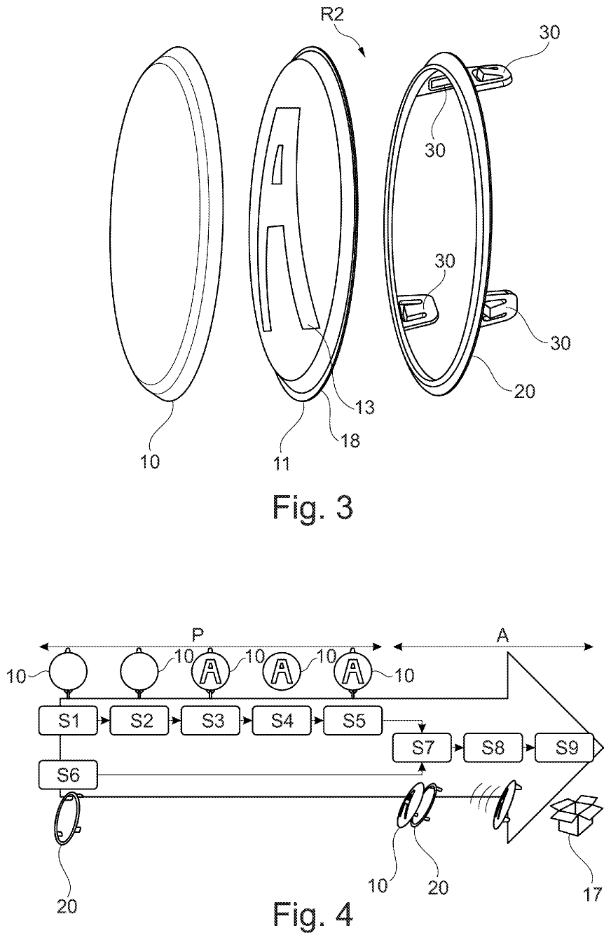

The radome R2 further comprises an optional frame 20 to which the covering plate 10 can be fixed (see FIG. 3) or is fixed (see FIG. 2). The covering plate 10 has no step geometry or structure, which would disturb electromagnetic waves, in particular radar waves. Furthermore, the covering plate 10 is a single plate that covers the opening. The electromagnetic waves pass through an inner area of the covering plate 10, where no frame material is present. Thus, the radome R2 is advantageous with regard to the radiation and/or detection of radar waves. Furthermore, the frame 20 has no geometry or structure in the area where radar waves cross the device. Due to the use of a single covering plate 10 in the radome R2, the material thickness is reduced in comparison with radome R1. Furthermore, air gaps do not occur. Thus, radar performance can be effectively improved.

The frame 20 comprises one or more fasteners 30 for fixing the device to the vehicle body (not shown). These fasteners 30 serve to attach the device to the opening of the vehicle body and they can be part of a snap fit system 7 with clips 8 and/or they can provide glue areas for gluing the radome R2 to counter areas of the vehicle body. In alternative embodiments, the fasteners 30 can be arranged on the covering plate 10, so that a separate frame 20 is not required. The covering plate 10 and the frame 20 can also be joined together by known joining techniques, such as laser welding or 2 K molding.

The covering plate 10 according to the depicted embodiment is slightly domed. Thus, the covering plate 10 is convexly shaped on the side which is facing away from the opening, when the device is fixed to the vehicle body in accordance with its intended use. Hence, the covering plate 10 has the form of a curved disc and is bent towards the outside of the vehicle.

FIG. 3 shows the covering plate 10, a metallization layer 18, and a frame 20 which has a ring-like form. The frame 20 at least in substance runs around the opening when the device is fixed to the vehicle body. Then, the covering plate 10 is fixed to the frame 20, for example by gluing.

The metallization layer 18 can be a component of or can form a styling layer 11 that covers a rear side 13 of the covering plate 10. The styling layer 18 can also be a foil on which styling is applied. Thus, the foil can bear a finished design. In this case the foil is attached to the covering plate, for example by hot stamping. Alternatively, the foil can be in-molded with the covering plate, which is preferably made of a transparent material, for example polycarbonate. No laser removal or painting processes are needed. A gluing step is also not required.

As shown in FIG. 3, from the styling layer 11, material has been partially removed for producing an emblem of the manufacturer of the vehicle on the front side 13. The area of the removed material corresponds to an “A” in FIG. 3, but the contour of the area can be such as to reflect a shape of a manufacturer's emblem. Thus, a final look on the front side can be obtained. Material removal can be achieved in particular by laser de-metallization.

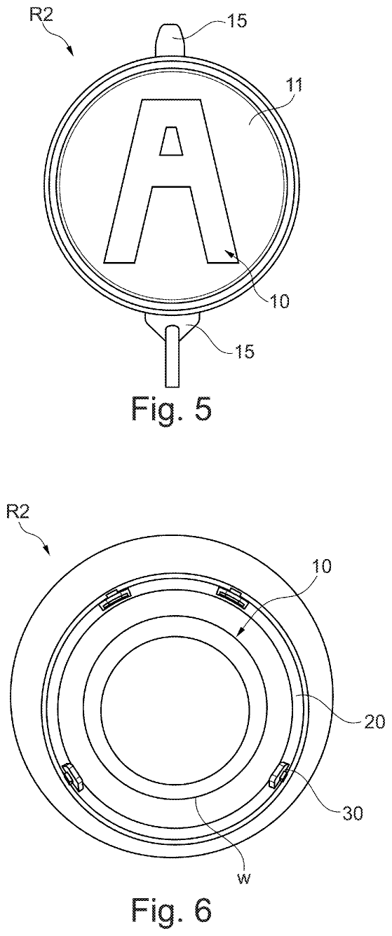

In a following step sprues 15 (see FIG. 5) can be cut from the covering plate 10.

As shown in FIG. 3, the frame 20 comprises four fasteners 30 for fixing the radome R2 to the vehicle body. The fasteners 30 can also be glued or can be mechanically fixed to the opening of the vehicle body. Other ways of mounting the device to the vehicle are basically also possible. The covering plate 10 can be fixed, in particular by gluing, laser welding or 2 K molding, to the frame 20.

With reference to the flow diagram of FIG. 4, in step S1 a covering plate 10 is produced in a molding process. The material of the covering plate 10 is at least partially transparent to electromagnetic waves, in particular radar waves, and optionally, it can be at least partially transparent to light waves. The covering plate 10 is molded by use of a plastic material. Other materials being at least partially transparent to electromagnetic waves are also possible.

In step S2 at least a rear side of the covering plate 10 is at least partially covered by a styling layer of a cover material, which is in particular a metal. Step S2 can include the step of providing a metallization on the rear side of the covering plate 10. Used metals are for example indium, gold, germanium, heavy metals and/or rare earths. A chrome look is preferably obtained. A covering of at least a part of the front side of the covering plate 10 is alternatively or cumulatively also possible.

In step S3 material is removed from the styling layer. Thus, an emblem (see “A” in FIG. 4) of a manufacturer of a vehicle is at least partly produced for example on the front side of the styling layer and thus visible on the front side of the covering plate 10. The removal of the styling layer material is conducted by application of a laser beam. Accordingly, a styling of the covering plate 10 can be ensured by laser de-metallization. Other methods like pad printing or usage of foils are also possible for material shaping.

In step S4, sprues 15 (see FIG. 5) are removed from the covering plate 10. In step S5, a lacquering is provided on the covering plate 10, in particular on the front side of the covering plate 10. Thus, the device can be protected against environmental influences. The lacquer can be transparent or can be colored according to the desired emblem. Illumination effects also can be considered by the application of the lacquer. In some embodiments, the step of laser removal can be repeated and thus applied two or more times. For example, for a first time to remove metallization, and for a second time to remove lacquer/paint, so that this part of covering plate is light transparent. Metallization and lacquering can be performed at least partially on the front side and/or the rear side of the covering plate 10.

As part of so-called preproduction processes P, a step S6 comprises producing a frame 20, preferably by use of a molding process. The frame 20 comprises one or more fasteners 30 for fixing the device to an opening of a vehicle body.

After the preproduction processes P, assembly processes A are executed. In step S7, the covering plate 10 is fixed to the frame 20. The fixing is conducted by gluing. Other fixing methods for example like fixing by mechanically clamping is also possible. In step S8, the efficiency of permeability for electromagnetic waves, in particular radar waves, of the covering plate 10 is measured. In step S9, the radar dome is packed for storage or transport purposes in a box 17.

The shown flow diagram is only an example. In particular, some steps can be performed in a different order. For example, the sprue cutting step could be carried out at an earlier or later stage. The process of lacquering could be carried out at an earlier or later stage, or such process could be carried out twice or even several times. The laser removal step can also be carried out several times.

FIG. 5 shows the covering plate 10 after step S5 of lacquering. As an example for an emblem, FIG. 5 depicts a removed inscription letter “A”. The removal was performed by laser de-metallization in step S3.

The thickness of the metal styling layer 11 is in a range of Accordingly, material from the styling layer 11 is removed in step S3 until a deepness also in a range of μm is obtained. The thickness of lacquer can also be in a range of As a result formed thickness changes are small such that efforts for thickness compensation for example by applying lacquer can be reduced.

FIG. 6 shows a beam of an electromagnetic wave W, in particular a radar wave, merely crossing the covering plate 10. Radar waves pass mainly through the covering plate 10. There is no substantial intersection from the frame 20, and there are no air gaps between two superimposed layers. The thickness of the covering plate 10 is constant and small. Thus, the performance of a radar system can be improved.

### LIST OF REFERENCE SIGNS

10 covering plate
20 frame
30 fastener
R1 radome
R2 radome
W electromagnetic wave
P preproduction
A assembly
S step
1 front plate
3 back plate
5 styling
7 snap-fit system
8 clips
9 air gap
11 styling layer
13 front side
15 sprue
17 box
18 metallization layer

1. A device for attachment to an opening of a vehicle and for covering an emitter and/or a receiver of electromagnetic waves (W), the device arranged in the vehicle behind the opening, the device comprising:
a covering plate which, when attached to the opening, completely covers the opening,
wherein the covering plate is composed of a material being at least partially transparent to the electromagnetic waves, and
wherein the covering plate being the only plate that covers completely the opening.

2. The device according to claim 1, further comprising a frame to which the covering plate is fixable, wherein the frame comprises one or more fasteners for fixing the device to the vehicle.

3. The device according to claim 2, wherein the frame extends substantially around the opening when the device is fixed to the vehicle body.

4. The device according to claim 2, wherein the frame has a ring-like form.

5. The device according to claim 2, wherein the covering plate and the frame are separated pieces or are integrally formed with each other.

6. The device according to claim 1, wherein the covering plate comprises one or more fasteners for fixing the device to the vehicle, the covering plate and the fasteners being integrally formed with each other.

7. The device according to claim 1, wherein the covering plate provides a homogenous layer and/or has at least a substantially consistent thickness and/or a circular circumference.

8. The device according to claim 1, wherein the covering plate is at least slightly domed.

9. The device according to claim 1, wherein the covering plate at least partially consists of a molded plastic material.

10. The device according to claim 1, wherein a front side and/or a rear side of the covering plate is at least partially covered by at least one styling layer of a cover material.

11. The device according to claim 10, wherein the at least one styling layer is manufactured such as to represent the emblem of the manufacturer of the vehicle.

12. A method of producing a device for attachment to an opening of a vehicle and for covering an emitter and/or a receiver of electromagnetic waves, the device being arranged in the vehicle behind the opening, the method comprising the steps of:
providing a covering plate which, when attached to the opening, completely covers the opening and is the only plate that covers completely the opening, the covering plate being comprised of a material that is at least partially transparent to electromagnetic waves,
at least partially covering at least a front and/or a rear side of the covering plate by a styling layer of a cover material, and
removing material from the styling layer for producing an emblem of the manufacturer of the vehicle on the front and/or the rear side of the covering plate, or using a foil as cover material and producing the emblem in the foil.

13. The method of claim 12, wherein the covering plate is produced in a molding process.

14. The method of claim 12, wherein the styling layer is produced by metallization of the covering plate.

15. The method of claim 12, wherein the step of removing material from the styling layer for producing an emblem of the manufacturer of the vehicle on the front and/or the rear side of the covering plate further comprises one or more steps in which a laser is used for removing material from the styling layer.

16. The method of claim 12, wherein at least one lacquering step is performed on the covering plate.

17. The method of claim 12, wherein the method further comprises the step of providing a frame with one or more fasteners for fixing the device to the vehicle body, wherein, the frame is provided by a molding process.

18. The method of claim 17, wherein the covering plate is fixed to the frame (20).

19. The method of claim 12, further comprising the step of measuring an efficiency of passage of electromagnetic waves through the covering plate.
